(19) United States
(12) Patent Application Publication
(10) Pub. No.: US 2009/0100249 A1
(43) Pub. Date: Apr. 16, 2009

(54) METHOD AND APPARATUS FOR ALLOCATING ARCHITECTURAL REGISTER RESOURCES AMONG THREADS IN A MULTI-THREADED MICROPROCESSOR CORE

(76) Inventors: ALEXANDRE E. EICHENBERGER, Chappaqua, NY (US); Michael Karl Gschwind, Chappaqua, NY (US); John A. Gunnels, Yorktown Heights, NY (US)

Correspondence Address: PATTERSON & SHERIDAN LLP;IBM CORPORATION, 595 SHREWSBURY AVE, SUITE 100, SHREWSBURY, NJ, 07702, US

(21) Appl. No.: 11/869,838

(22) Filed: Oct. 10, 2007

(51) Int. Cl. G06F 9/38; G06F 9/02

(52) U.S. Cl. 712/42; 712/E09.002; 712/E09.045

(57) ABSTRACT

One embodiment of a microprocessor core capable of executing a plurality of threads substantially simultaneously includes a plurality of register resources available for use by the threads, where the register resources are fewer in number than the number threads multiplied by a number of architectural register resources required per thread, and a supervisor for allocating the register resources among the plurality of threads.

### FIELD OF THE INVENTION

The invention relates generally to microprocessor memory and relates more particularly to resource allocation among threads in multithreaded microprocessor cores.

### BACKGROUND OF THE INVENTION

In conventional multithreaded microprocessor cores, each thread architecturally is allocated a standard set of architectural register resources. For example, each thread will, by default, be allocated a full set of registers. Thus, the total number, t, of threads that can be supported simultaneously by a core is limited by the total architectural register resources available to the core. For instance, the number, t, of threads multiplied by the number, r, of registers per thread cannot exceed the total number, R, of registers (i.e., R≧t*r).

A problem with this approach, however, is that a thread may not always require all of the architectural register resources allocated to it. Thus, a good deal of architectural register resources allocated to a particular thread may go unused. For example, despite being allocated a full set of registers, an online transaction processing (OLTP) workload will rarely use floating point registers. As another example, few workloads use vector registers. This situation is especially undesirable as multi-core processors get smaller; in order to accommodate two or more cores on the microprocessor chip, a full set of architectural register resources is required for each core, thereby demanding more of the already limited space on the chip and perhaps unnecessarily increasing the hardware implementation cost.

Thus, there is a need in the art for a method and apparatus for allocating architectural register resources among threads in a multi-threaded microprocessor core.

### SUMMARY OF THE INVENTION

One embodiment of a microprocessor core capable of executing a plurality of threads substantially simultaneously includes a plurality of register resources available for use by the threads, where the register resources are fewer in number than the number threads multiplied by a number of architectural register resources required per thread, and a supervisor for allocating the register resources among the plurality of threads.

### BRIEF DESCRIPTION OF THE DRAWINGS

So that the manner in which the above recited embodiments of the invention are attained and can be understood in detail, a more particular description of the invention, briefly summarized above, may be obtained by reference to the embodiments thereof which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a schematic diagram illustrating one embodiment of a multi-threaded microprocessor core, according to the present invention;

FIG. 2 is a schematic diagram illustrating one embodiment of a register space mapper, according to the present invention;

FIG. 3 is a schematic diagram illustrating one embodiment of a thread-to-register bank mapper, according to the present invention;

FIG. 4 is a flow diagram illustrating one embodiment of a method for determining and assigning architectural levels to threads, according to the present invention;

FIG. 5 is a flow diagram illustrating one embodiment of a method for de-allocating architectural register resources from a thread, according to the present invention;

FIG. 6 is a flow diagram illustrating a second embodiment of a method for determining and assigning architectural levels to threads, according to the present invention; and

FIG. 7 is a high level block diagram of the present invention implemented using a general purpose computing device.

To facilitate understanding, identical reference numerals have been used, where possible, to designate identical elements that are common to the figures.

### DETAILED DESCRIPTION

This invention relates to method and apparatus for allocating architectural register resources among threads in a multi-threaded microprocessor core. Embodiments of the invention allow simultaneous sharing of register resources among multiple threads within a multithreaded microprocessor core, at the architecture level, by providing a set of architectural register resources that is fewer than the number of threads. Thus, for instance, in the case of registers, the total number, R, of registers available to a core may be less than the number, t, of supportable threads multiplied by the number, r, of registers per thread (i.e., R<t*r). Threads are thus reduced in architectural compliance (e.g., cannot use vector registers or cannot use floating points registers), allowing available architectural register resources to be used more efficiently and reducing the amount of space on the microprocessor chip occupied by the register resources.

Although the present invention will be described within the context of register allocation, those skilled in the art will appreciate that the present invention may apply equally to any resources allocated to a thread within a microprocessor core.

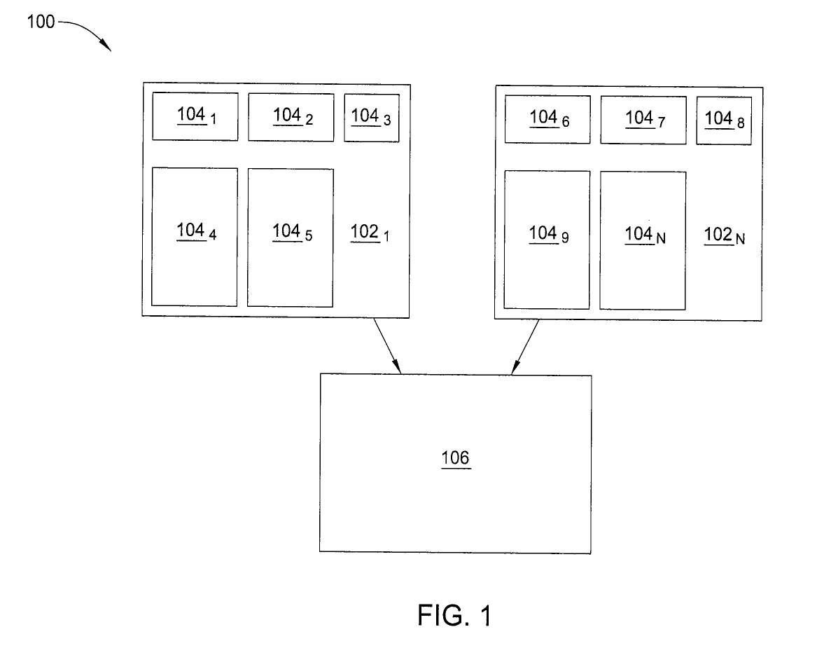

FIG. 1 is a schematic diagram illustrating one embodiment of a multi-threaded microprocessor core 100, according to the present invention. As illustrated, the core 100 executes a plurality of hardware threads 102₁-102ₙ (hereinafter collectively referred to as “threads 102”).

Each thread 102 is allocated a plurality of dedicated architectural register resources 104₁-104ₙ (hereinafter collectively referred to as “architectural register resources 104”). These architectural register resources 104 comprise registers, including, but not limited to, at least one of: a program counter, a link register, a count register, a general purpose register, a floating point register, or a vector register.

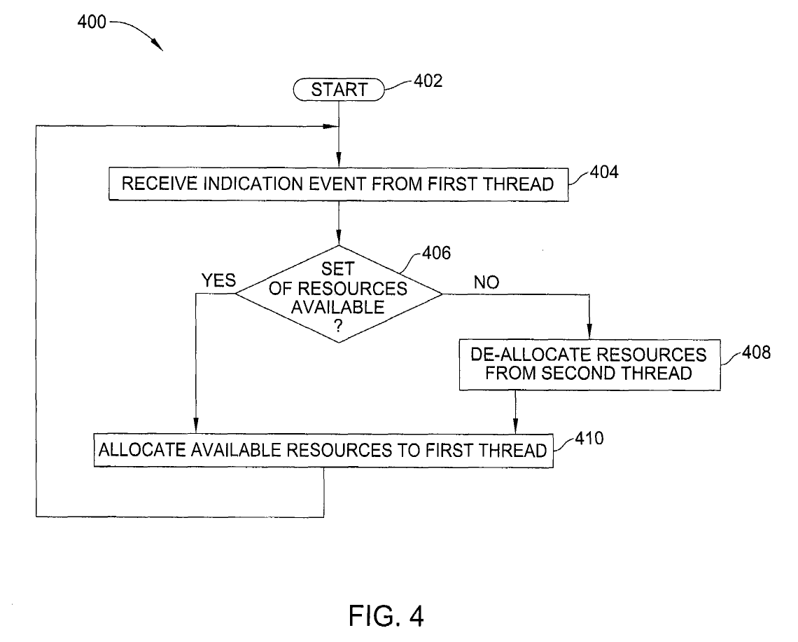

In addition, one or more shared architectural register resources 106 are shared by the threads 102. Shared architectural register resources comprise registers, including, but not limited to, vector registers. In one embodiment, access to a shared resource 106 by one of the threads 102 is disabled when another of the threads 102 is using the shared architectural register resource 106. For example, if the thread 102₁ is using the shared architectural register resource 106, access to the shared architectural register resource 106 by the thread 102ₙ may be disabled. The thread 102ₙ is thus said to have a reduced architecture compliance level. In one embodiment, when the thread 102ₙ attempts to access the shared architectural register resource 106 while the shared architectural register resource is in use by the thread 102₁, an exception is raised and is resolved by a supervisor (e.g., the operating system). One embodiment of a method for resolving exceptions is discussed in further detail with respect to FIG. 4.

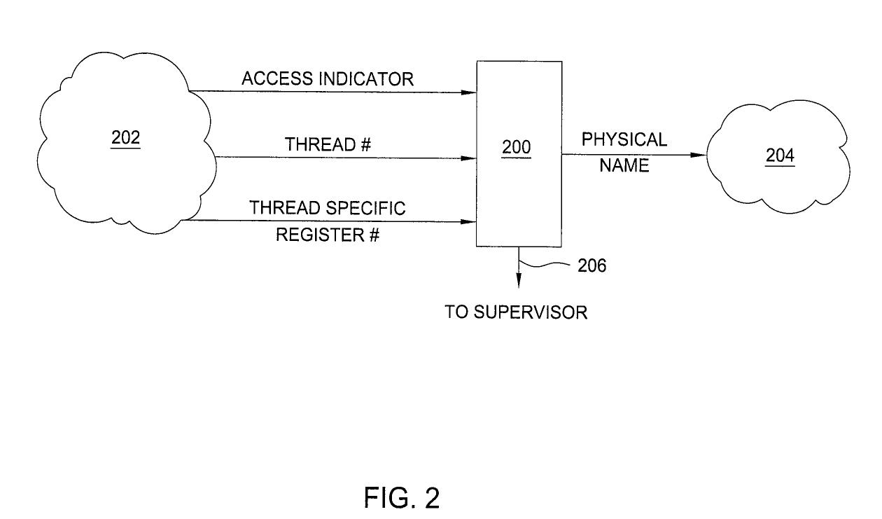

FIG. 2 is a schematic diagram illustrating one embodiment of a register space mapper 200, according to the present invention. The mapper 200 may be used in conjunction with the present invention to associate an architectural register of a thread with a set of physical registers (if the microprocessor is so configured). In a particular embodiment, the mapper 200 may be used in conjunction with a microprocessor that uses register renaming.

The mapper 200 comprises a lookup table or similar mechanism that maps a specific register number to physical space. Thus, the mapper may be used to locate shared architectural register resources, such as shared registers.

As illustrated, the mapper 200 receives from a first instruction unit 202 (which includes functions generally relating to instruction fetch and decode) an access indicator, a thread number, and a thread-specific register number. The access indicator indicates that an access is requested, and in some embodiments indicates the type of access requested (e.g., a “valid” signal, and an indication as to whether a read or write access should be performed). This information allows the mapper 200 to determine which register number a thread wishes to use.

Once the mapper 200 determines the physical location of the register number that the thread wishes to use, the mapper 200 provides the physical name of the register to a second instruction unit 204 (which includes functions generally relating to register access and instruction execution). As illustrated, if the requested access is incompatible with an architecture-level indicator associated with the thread responsive to supervisor resource allocation and architecture-level selection, the mapper allows a supervisor (e.g., the operating system) to resolve the request with an indication signal 206 to initiate an indication event (e.g., processor interrupt, or exception, to transfer control to a supervisor).

Those skilled in the art will understand that in some embodiments, the first instruction unit 202 and the second instruction unit 204 may correspond to different components of a single instruction unit. In such an embodiment, the components corresponding to the first instruction unit 202 generally relate to fetch and decode instructions, while the components corresponding to the second instruction unit 204 generally relate to dispatch and issue instructions.

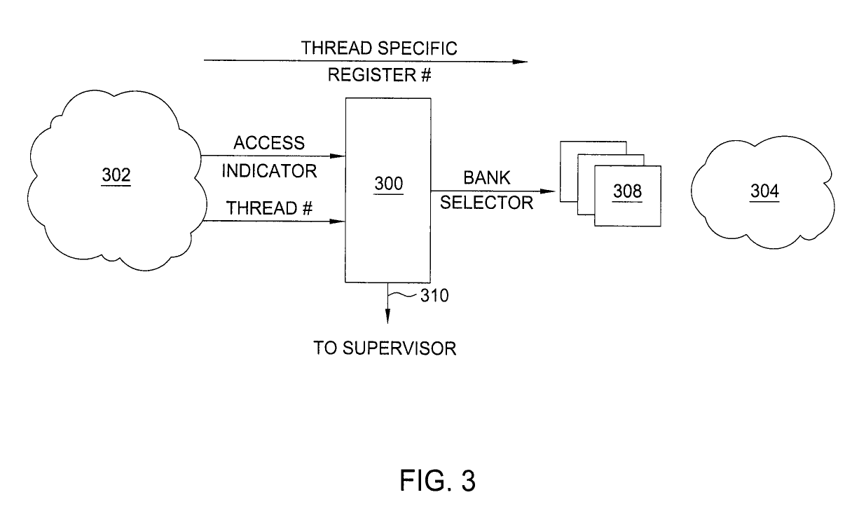

FIG. 3 is a schematic diagram illustrating one embodiment of a thread-to-register bank mapper 300, according to the present invention. The mapper 300 is an alternative to the mapper 200 illustrated in FIG. 2 and may be used in conjunction with the present invention to associate an architectural register of a thread with a set of physical registers (if the microprocessor is so configured). In a particular embodiment, the mapper 300 may be used in conjunction with a microprocessor that does not use register renaming.

The mapper 300 comprises a lookup table or similar mechanism that maps a specific thread to a bank of registers 308. Thus, the mapper may be used to locate shared architectural register resources, such as shared registers.

As illustrated, the mapper 300 receives from a first instruction unit 302 (which includes functions generally relating to instruction fetch and decode) an access indicator and a thread number. This information allows the mapper 300 to determine which bank of registers 308 contains the register corresponding to a thread.

Once the mapper 300 determines the bank of registers 308 that corresponds to the thread, the mapper 300 provides an indicator corresponding to a specific bank of registers 308 to a second instruction unit 304 (which includes functions generally relating to register access and instruction execution). A thread-specific register number provided by the first instruction unit 302 further allows the second instruction unit 304 to determine which register within the bank of registers 308 the thread wishes to use. As illustrated, if the requested access is incompatible with an architecture-level indicator associated with the thread responsive to supervisor resource allocation and architecture-level selection, the mapper allows a supervisor (e.g., the operating system) to resolve the request with an indication signal 310 to initiate an indication event (e.g., processor interrupt, or exception, to transfer control to a supervisor).

Those skilled in the art will understand that in some embodiments, the first instruction unit 302 and the second instruction unit 304 may correspond to different components of a single instruction unit. In such an embodiment, the components corresponding to the first instruction unit 302 generally relate to fetch and decode instructions, while the components corresponding to the second instruction unit 304 generally relate to dispatch and issue instructions.

FIG. 4 is a flow diagram illustrating one embodiment of a method 400 for determining and assigning architectural levels (architectural register resource sets) to threads, according to the present invention. The method 400 may be implemented, for example, by a supervisor that resolves conflicts with respect to request architectural register resource access by multiple threads, as discussed above. Thus, the supervisor uses the method 400 to manage requests for a finite number of architectural register resources among a plurality of potential requesters (where management of the requests may also account for service-level agreements or other criteria).

The method 400 is initialized at step 402 and proceeds to step 404, where the method 400 receives an indication event (corresponding to an indication event such as the indication events indicated by indication signals 206 and 310 illustrated in FIGS. 2 and 3, respectively) from a first thread. The indication event indicates that the first thread requires architectural register resources corresponding to an architecture level for which the thread is not currently configured.

In step 406, the method 400 determines whether there are architectural register resources available to allocate to the first thread. If the method 400 concludes in step 406 that there are architectural register resources available to allocate to the first thread, the method 400 proceeds to step 410 and allocates the available architectural register resources to the first thread. The method 400 then returns to step 404 and waits for a next indication event.

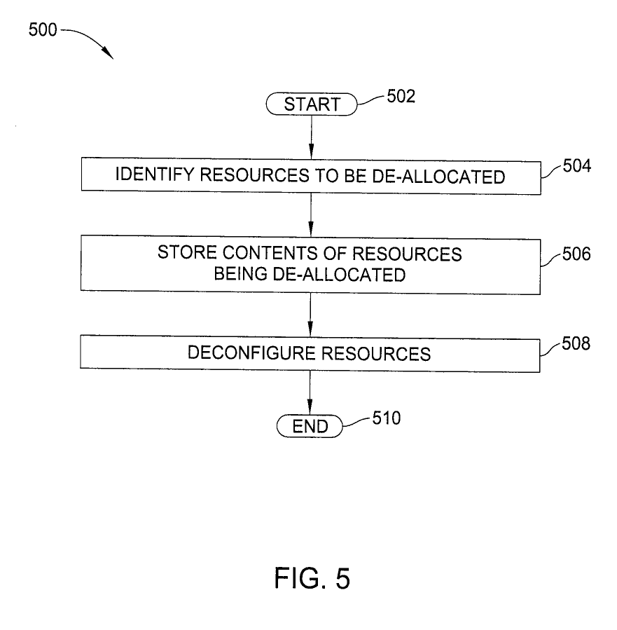

Alternatively, if the method 400 concludes in step 406 that there are no architectural register resources available to allocate to the first thread, the method 400 proceeds to step 408 and de-allocates architectural register resources from a second thread to make available architectural register resources, before proceeding to step 410 and allocating the newly available architectural register resources to the first thread. In conjunction with de-allocating architectural register resources, the architecture level indicator is updated to indicate a reduced architecture level for the second thread, as described in further detail with respect to FIG. 5. In one embodiment, the second thread is currently using the de-allocated architectural register resources. In a further embodiment, the second thread is the thread that has been using the desired architecture level (i.e., required architectural register resources) for the longest period of time. In another embodiment, the second thread is merely requesting the de-allocated architectural register resources at the same time that the first thread is requesting the architectural register resources.

In some embodiments, one physical register resource may be used to satisfy different architectural requirements (e.g., architectural vector registers for use with single instruction, multiple data (SIMD) instructions or architectural scalar registers for use with floating point instructions), and so an architectural register resource of one type may be de-allocated from one thread and allocated to another thread. Alternatively, an architectural register resource of one type may be de-allocated from one thread and allocated to another architectural use. Moreover, more than one architectural register resource may be used to satisfy a single request, while a single architectural register resource may suffice to satisfy another request.

FIG. 5 is a flow diagram illustrating one embodiment of a method 500 for de-allocating architectural register resources from a thread, according to the present invention. The method 500 may be implemented, for example, by a supervisor that resolves conflicts with respect to request architectural register resource access by multiple threads (e.g., in accordance with step 408 of the method 400).

The method 500 is initialized at step 502 and proceeds to step 504, where the method 500 identifies the architectural register resources (e.g., a set of registers) to be de-allocated. The method 500 then proceeds to step 506 and stores the contents of the architectural register resources being de-allocated. In another embodiment, the method 500 first determines in step 506 if the contents of each architectural resource being de-allocated have been modified since last being allocated. The method 500 then stores the contents of the architectural resources being de-allocated, possibly with modified content. Any one or more of a number of methods may be used to determine if the contents have been modified, including, but not limited to, using an extra bit for each architectural resource, where the extra bit is reset upon allocation and set upon modification of content.

The method 500 then deconfigures the architectural register resources in step 508. In one embodiment, architectural deconfiguration is accomplished using an architecture enable/disable facility, such as an architecture level indicator or bit that indicates whether a facility is available (e.g., similar to the known MSR[FP] bit defined in accordance with the IBM Power Architecture™, commercially available from International Business Machines Corp. of Armonk, N.Y.). In this embodiment, the method 500 also and updates the architecture level indicator in step 508 to indicate the reduced architecture level before terminating in step 510.

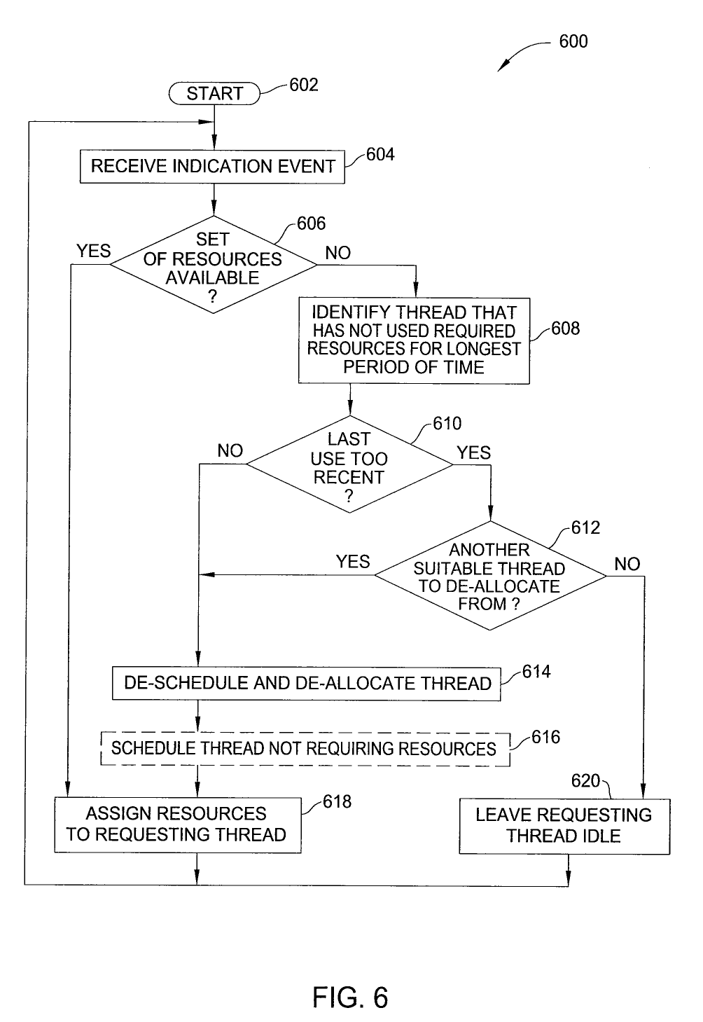

FIG. 6 is a flow diagram illustrating a second embodiment of a method 600 for determining and assigning architectural levels (architectural register resource sets) to threads, according to the present invention. The method 600 may be implemented, for example, by a supervisor that resolves conflicts with respect to request architectural register resource access by multiple threads, as discussed above. Thus, the supervisor uses the method 600 to manage requests for a finite number of architectural register resources among a plurality of potential requesters (where management of the requests may also account for service-level agreements or other criteria).

The method 600 is initialized at step 602 and proceeds to step 604, where the method 600 receives an indication event from a first thread. The indication event indicates that the first thread requires architectural register resources.

In step 606, the method 600 determines whether there are architectural register resources available to allocate to the first thread. If the method 600 concludes in step 606 that there are architectural register resources available to allocate to the first thread, the method 600 proceeds to step 618 and allocates the available architectural register resources to the first thread. The method 600 then returns to step 604 and waits for a next indication event.

Alternatively, if the method 600 concludes in step 606 that there are no architectural register resources available to allocate to the first thread, the method 600 proceeds to step 608 identifies a second thread from which to potentially de-allocate the required architectural register resources. Specifically, in step 608, the method 600 identifies the thread that has not used (or requested) the desired architecture level (i.e., required architectural register resources) for the longest period of time.

In step 610, the method 600 determines whether the last time the second thread identified in step 608 used the required architectural register resources was too recent (e.g., occurred within a threshold period of time). In one embodiment, the threshold period of time is defined by a management module (not shown). If the method 600 concludes in step 610 that the last use was not too recent, the method 600 proceeds to step 614 and de-schedules and de-allocates the second thread to make the architectural register resources available to the first thread. In one embodiment, whenever a thread is de-scheduled (e.g., during a normal context switch), the context switch function of the supervisor software always de-allocates the corresponding architectural register resources.

In optional step 616 (illustrated in phantom), the method 600 schedules a third thread that does not require the architectural register resources just de-allocated for use by the first thread, or has such architectural register resources allocated to it.

In step 618, the method 600 assigns the de-allocated architectural register resources to the first thread before returning to step 604 and waiting for a next indication event. In one embodiment, whenever a new thread is scheduled, the new thread is always scheduled with the de-allocated architectural register resources.

Although the methods 400 and 600 are described as being implemented by a supervisor in the operating system (e.g., such that there is substantially no change to user applications), those skilled in the art will appreciate that a supervisor for discovering architectural resource need and for provisioning architectural register resources corresponding to architectural requirements may be implemented. For instance, such a supervisor could be implemented completely in hardware, in a hypervisor (e.g., such that there is substantially no change to the operating system and applications), or in the applications themselves (e.g., such that the applications provide hints or assurances with respect to their architectural requirements).

In the case where the supervisor is implemented in the operating system, architectural usage by applications can be discovered in a number of potential ways. For instance, a measurement apparatus may be used, such as a counter that indicates whether, over a given time period, architectural register resources corresponding to a certain architecture level were used. Alternatively, software methods may be used, such as methods that periodically de-allocate architectural register resources and track whether the de-allocated architectural register resources are requested (e.g., by indicating a signal of a given apparatus).

In the case where the supervisor is implemented with application support, architectural usage by applications can be discovered in a number of potential ways. For instance, a specific application may indicate that it does not require a given architectural level (e.g., does not require floating point registers). This can be indicated through an indicator in the application binary (e.g., a field in an executable and linkable format (ELF) header of the application binary, in accordance with the ELF format specification, or a similar indicator in another file format which is then extracted by the program loader of the operating system), through a system call to the operating system, by writing a value to a specific location (e.g., in address space) from which architectural requirements can be read, or by other methods. Alternatively, the regions corresponding to architectural requirements (e.g., regions with/without floating point registers) can be indicated dynamically, for example by a system call to the operating system, by indication to a specific location from which architectural requirements can be read, or by other methods.

In another embodiment, the usage of architectural register resources corresponding to architectural levels can be determined by supervisor software, by de-allocating architectural register resources when a thread is scheduled and determining usage by way of indication events (e.g., indication events indicated by indication signals 206 and 310 of FIGS. 2 and 3, respectively).

In yet another embodiment, hardware (e.g., performance monitor counters or other resource metering logic) is used to track the use of specific architectural resources.

Moreover, it will be appreciated that some register resources can be shared between different architectural levels. For instance, registers can be allocated to either a SIMD VMX unit or to floating point unit (FPU). Different quantities of register resources can also be allocated (e.g., two banks of thirty-two-entry sixty-four-bit registers may be allocated as one SIMD VMX register file, or one bank of registers may be allocated as a scalar FPU register file). This may require the de-allocation of architectural register resources from several threads (e.g., use one register bank to obtain two assignable banks). Alternatively, one register resource may provision the widest facility, or an architecture level may exist that uses a unified register file, while another architecture level uses separate disjoint scalar and SIMD register files.

Alternatively, if the method 600 concludes in step 610 that the last use by the second thread was too recent, the method 600 proceeds to step 612 and determines whether there is another, suitable thread exists from which to de-allocate the required architectural register resources (i.e., a fourth thread). If the method 600 concludes in step 612 that such a fourth thread does exist, the method 600 proceeds to step 614 and continues as described above to de-schedule and de-allocate the fourth thread.

Alternatively, if the method 600 concludes in step 612 that such a fourth thread does not exist, the method 600 proceeds to step 620 and leaves the first thread (i.e., the requesting thread) at least temporarily idle before returning to step 604 and waiting for a next indication event.

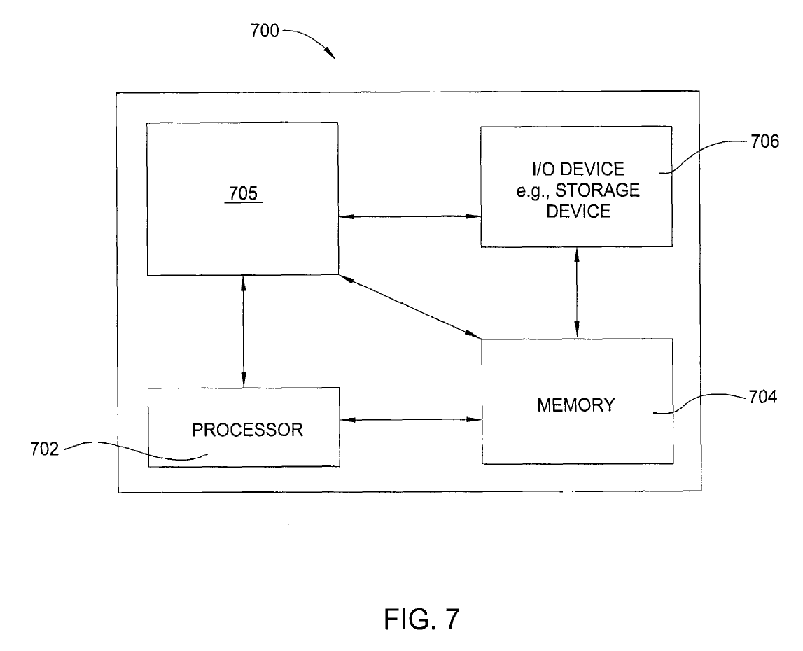

FIG. 7 is a high level block diagram of the present invention implemented using a general purpose computing device 700. It should be understood that the resource allocation engine, manager or application (e.g., for allocating architectural register resources among threads) can be implemented as a physical device or subsystem that is coupled to a processor through a communication channel. Therefore, in one embodiment, a general purpose computing device 700 comprises a processor 702, a memory 704, a resource allocation module 705 and various input/output (I/O) devices 706 such as a display, a keyboard, a mouse, a modem, and the like. In one embodiment, at least one I/O device is a storage device (e.g., a disk drive, an optical disk drive, a floppy disk drive).

Alternatively, the resource allocation engine, manager or application (e.g., resource allocation module 705) can be represented by one or more software applications (or even a combination of software and hardware, e.g., using Application Specific Integrated Circuits (ASIC)), where the software is loaded from a storage medium (e.g., I/O devices 706) and operated by the processor 702 in the memory 704 of the general purpose computing device 700. Thus, in one embodiment, the resource allocation module 705 for allocating architectural register resources among threads in a multi-threaded core of a microprocessor described herein with reference to the preceding Figures can be stored on a computer readable medium or carrier (e.g., RAM, magnetic or optical drive or diskette, and the like).

It should be noted that although not explicitly specified, one or more steps of the methods described herein may include a storing, displaying and/or outputting step as required for a particular application. In other words, any data, records, fields, and/or intermediate results discussed in the methods can be stored, displayed, and/or outputted to another device as required for a particular application. Furthermore, steps or blocks in the accompanying Figures that recite a determining operation or involve a decision, do not necessarily require that both branches of the determining operation be practiced. In other words, one of the branches of the determining operation can be deemed as an optional step.

Although various embodiments which incorporate the teachings of the present invention have been shown and described in detail herein, those skilled in the art can readily devise other embodiments without departing from the basic scope of the present invention.

What is claimed is:

1. A microprocessor core capable of executing a plurality of threads substantially simultaneously, comprising:
a plurality of architectural register resources available for use by the plurality of threads, where the plurality of architectural register resources is fewer in number than the plurality of threads multiplied by a number of architectural register resources required per thread;
an architecture level indicator set to correspond to the plurality of architectural register resources available for use; and
a supervisor for allocating the plurality of architectural register resources among the plurality of threads.

2. The microprocessor core of claim 1, wherein the plurality of architectural register resources comprises a plurality of registers.

3. The microprocessor core of claim 1, wherein the microprocessor core is configured to generate an indication event when an instruction corresponding to a non-configured one of the plurality of architectural register resources is to be executed, based on the architecture level indicator.

4. The microprocessor core of claim 3, wherein generating an indication event comprises:
raising an exception; and
transferring control over the allocating from the supervisor to an operating system or to a hypervisor.

5. The microprocessor core of claim 1, further comprising:
a mapper for mapping at least one of the plurality of threads to a bank of architectural register resources.

6. The microprocessor core of claim 1, further comprising:
a mapper for mapping at least one of the plurality of architectural register resources to a location in physical space.

7. A method for allocating a plurality of architectural register resources in a microprocessor core among a plurality of threads executing in the microprocessor core, the method comprising:
receiving a request for a subset of the plurality of architectural register resources from a first one of the plurality of threads;
de-allocating the subset of the plurality of architectural register resources from a second one of the plurality of threads, if the subset of the plurality of architectural register resources is not available; and
allocating the de-allocated subset of the plurality of architectural register resources to the first one of the plurality of threads.

8. The method of claim 7, wherein the de-allocating comprises:
identifying the second one of the plurality of threads from which to de-allocate the subset of the plurality of architectural register resources;
storing contents of the de-allocated subset of the plurality of architectural register resources; and
deconfiguring the subset of the plurality of architectural register resources.

9. The method of claim 8, wherein the identifying comprises:
determining which one of the plurality of threads has not used the subset of the plurality of architectural register resources for a longest period of time.

10. The method of claim 9, further comprising:
identifying an alternate one of the plurality of threads from which to de-allocate the subset of the plurality of architectural register resources, if a last use of the subset of the plurality of architectural register resources by the one of the plurality of threads has not used the subset of the plurality of architectural register resources for the longest period of time occurred within a predefined threshold of time.

11. The method of claim 10, further comprising:
de-scheduling the first one of the plurality of threads, if an alternate one of the plurality of threads cannot be identified.

12. The method of claim 7, further comprising:
scheduling a third one of the plurality of threads that does not require the subset of the plurality of architectural register resources.

13. A computer readable medium containing an executable program for allocating a plurality of architectural register resources in a microprocessor core among a plurality of threads executing in the microprocessor core, where the program performs the steps of:
receiving a request for a subset of the plurality of architectural register resources from a first one of the plurality of threads;
de-allocating the subset of the plurality of architectural register resources from a second one of the plurality of threads, if the subset of the plurality of architectural register resources is not available; and
allocating the de-allocated subset of the plurality of architectural register resources to the first one of the plurality of threads.

14. The computer readable medium of claim 13, wherein the de-allocating comprises:
identifying the second one of the plurality of threads from which to de-allocate the subset of the plurality of architectural register resources;
storing contents of the de-allocated subset of the plurality of architectural register resources; and
deconfiguring the subset of the plurality of architectural register resources.

15. The computer readable medium of claim 13, wherein the identifying comprises:
determining which one of the plurality of threads has not used the subset of the plurality of architectural register resources for a longest period of time.

16. The computer readable medium of claim 15, further comprising:
identifying an alternate one of the plurality of threads from which to de-allocate the subset of the plurality of architectural register resources, if a last use of the subset of the plurality of architectural register resources by the one of the plurality of threads has not used the subset of the plurality of architectural register resources for the longest period of time occurred within a predefined threshold of time.

17. The computer readable medium of claim 16, further comprising:
de-scheduling the first one of the plurality of threads, if an alternate one of the plurality of threads cannot be identified.

18. The computer readable medium of claim 13, further comprising:
scheduling a third one of the plurality of threads that does not require the subset of the plurality of architectural register resources.

19. Apparatus for allocating a plurality of architectural register resources in a microprocessor core among a plurality of threads executing in the microprocessor core, the apparatus comprising:
means for receiving a request for a subset of the plurality of architectural register resources from a first one of the plurality of threads;
means for de-allocating the subset of the plurality of architectural register resources from a second one of the plurality of threads, if the subset of the plurality of architectural register resources is not available; and
means for allocating the de-allocated subset of the plurality of architectural register resources to the first one of the plurality of threads.

20. The apparatus of claim 19, wherein the means for de-allocating comprises:
means for identifying the second one of the plurality of threads from which to de-allocate the subset of the plurality of architectural register resources;
means for storing contents of the de-allocated subset of the plurality of architectural register resources; and
means for deconfiguring the subset of the plurality of architectural register resources
